(19) United States
(12) Patent Application Publication
(10) Pub. No.: US 2006/0289124 A1
(43) Pub. Date: Dec. 28, 2006

(54) Grid strip component for shutters with pull cord

(75) Inventor: Tsung-Hsiung Tsai, Jhushan Township (TW)

Correspondence Address: John S. Egbert;Egbert Law Offices, 7th Floor, 412 Main Street, Houston, TX, 77002, US

(73) Assignee: TAIHAO KNITTING BELT Co., Ltd., Dongguan City (CN)

(21) Appl. No.: 11/165,559

(22) Filed: Jun. 23, 2005

(51) Int. Cl. E06B 9/382

(52) U.S. Cl. 160/178.3

(57) ABSTRACT

The grid strip component for shutters with pull cords includes a grid strip having two vertical strips that are spaced vertically with certain length set aside, and between the two vertical strips are several horizontal strips, and on both sides of the vertical strips are several pull cord loops. There are two pull cords, which are to go through several pull cord loops that are on the outsides of the vertical strips; moreover, the length of at least one end of the two pull cords should be extra long, and this extra length is the length needed to install the shutters; and by so doing, the grid strip of the present invention uses the unique pull cord to make the assembly more convenient and more effective.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a grid strip for shutters, and more particularly to a grid strip with pull cord.

### BACKGROUND OF THE INVENTION

When installing conventional shutters, the independent leaves and pull cord must be connected by the grid strip to be positioned; and the grid strip mentioned above comprises two vertical strips and between the two vertical strips are several horizontal strips, and on the two corresponding sides of the vertical strips are several rings. The purpose of placing the rings on both sides is to let a thin string go through, and the end of the thin string is lined up with the end of the vertical strip, and purpose of the thin string is to pull the pull cord (also call hang cord) of the shutters. The method is to tie the ends of the thin string and the pull cords together, then pull the thin string towards one end until the pull cord has gone through the ring completely to complete the installation of the pull cord; except, this conventional structure has the following issues in practical application: because the diameter of the ring on the outside of the vertical strip is small, and just enough room for the pull cord to go through, therefore, and the outer diameter of the place where the ends of the thin string and pull cord ties together is too think, therefore, it often causes the pull cord to be stuck by the ring when it goes through, which also causes problems during the operation.

Thus, to overcome the aforementioned problems of the prior art, it would be an advancement if the art to provide an improved structure that can significantly improve the efficacy.

### BRIEF SUMMARY OF THE INVENTION

1. Through the above structure and design, the main purpose of the grid strip disclosed in the present invention is to use the feature of the pull cords 20, and the design of the extra length left at the end 21 of the pull cord 20 to assemble the grid strip 10 and the shutters directly, which reduces the process of the pull cord being pulled by the thin string, to achieve a more convenient and more effective assembling process.

2. Another purpose of the grid strip structure disclosed in the present invention is to add the structure of the reel base 30, and using the reel base, which includes a first and second reel 31 32, for the storing of the grid strip 10 and two pull cords 20, so that the ends 21 of the grid strip 10 and pull cord 20 can be stored separately to keep them from being tangled up, and to make it more convenient to use.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the grid strip of the present invention.

FIG. 2 shows a magnified view of part A in FIG. 1.

FIG. 3 shows the assembling relationship of the grid strip and the shutters.

FIG. 4 shows an operating view of the component unit that has a reel base.

FIG. 5 shows another view of the grid strip when stored.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

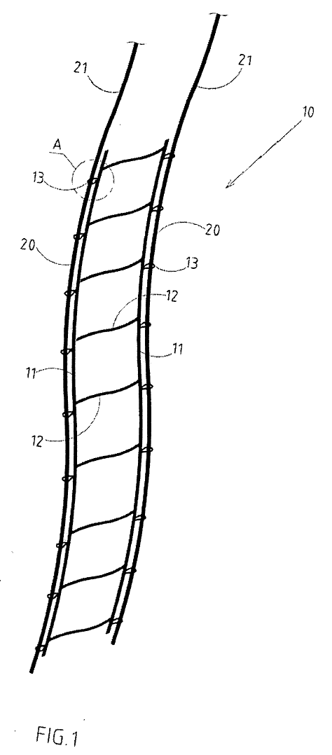

As shown in FIGS. 1-4, a preferred embodiment of the grid strip component for shutters with pull cord comprising:

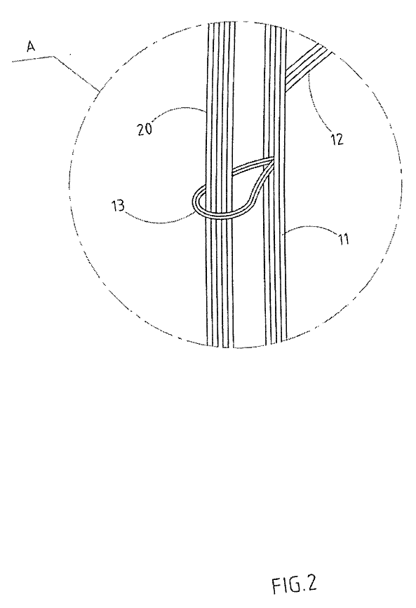

a grid strip 10, which includes two vertical strips 11 that are spaced vertically with certain length set apart, and between the two vertical strips 11 are several horizontal strips 12, and on both sides of the vertical strips are several pull cord loops 13 (as shown in FIG. 2);

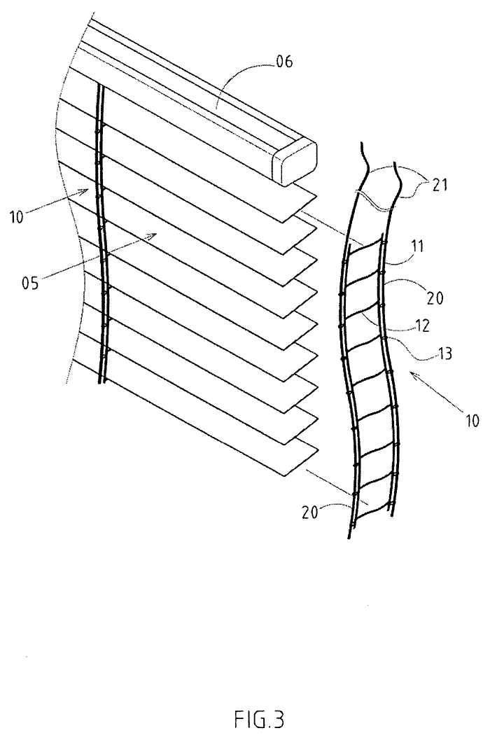

There are two pull cords 20, which are to go through several pull cord loops 13 that are on the outsides of the vertical strips 11 mentioned above; moreover, the length of at least one end 21 (in this embodiment is the top) of the two pull cords 20 should be extra long, and this extra length is the length needed to install the shutters 05, as shown in the FIG. 3 is the corresponding relationship of the grid strip 10 and the shutters 05, among them, the end of the pull cord 20 that is extra long can tread through a track 06 and a roller set and control components (not shown in the figure) on top of the shutter 05, and by so doing, it controls the pull cord 20, and moves the shutters 05, which is the reason why the ends 21 of the two pull cords 20 must have extra length set aside.

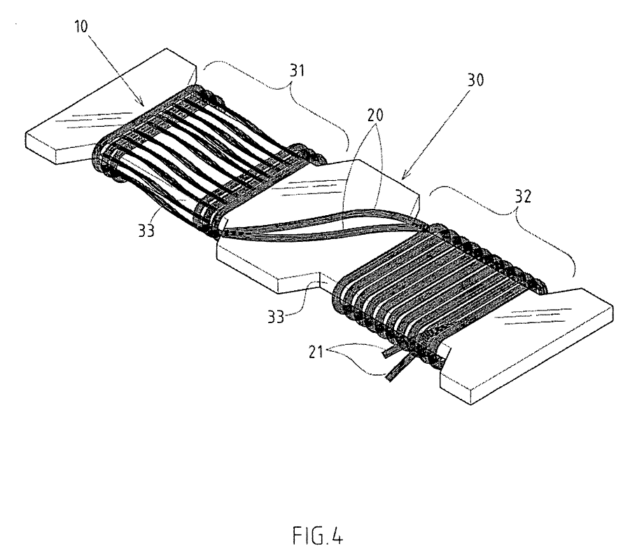

Among them, as shown in FIG. 4, the grid strip component for shutters with pull cord comprises a reel base 30, and among them, it has a first reel 31 and the second reel 32, and the first reel 31 is for storing the grid strip 10 mentioned above, and the second reel 32 is for storing the extra long ends 21 of the two pull cords 20 mentioned above; and among them, the reel base 30 of the embodiment is a rectangle plate (solid material preferred), and on the sides are the concave rims 33 that form the first reel 30 and the second reel.

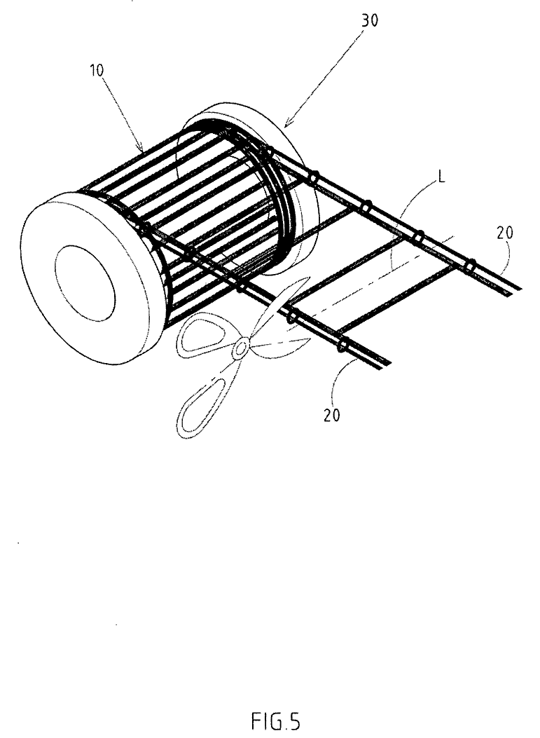

FIG. 5 shows another operational view of the grid strip component for shutters with pull cord; as shown in this figure, the ends of the grid strip 10 and the pull cord 20 are lined up, and the grid strip 10 and the pull cord 20 are rolled up in a reel base 30B, so that length may be decided and cut depends on the user's desire. (See the scissors and the imaginary cutting line L in the figure.)

1. A grid strip for shutters with a pull cord comprising:
a grid strip being comprised of two vertical strips spaced vertically with a certain length set apart, several horizontal strips between the two vertical strips, and several pull cord loops on both sides of the vertical strips; and
two pull cords through several pull cord loops that are on outsides of the vertical strips, the length of at least one end of the two pull cords being extra long, and having extra length needed to install shutters.

2. A grid strip for shutters with a pull cord comprising:
a grid strip being comprised of two vertical strips spaced vertically with a certain length set apart, several horizontal strips between the two vertical strips, and several pull cord loops on both sides of the vertical strips;
two pull cords through several pull cord loops that are on outsides of the vertical strips, the length of at least one end of the two pull cords being extra long, and having extra length needed to install shutters; and
a reel base being comprised of a first reel and the second reel, the first reel storing the grid strip, the second reel storing extra long ends of the two pull cords.

3. The structure defined in claim 2, wherein said reel base is a rectangle plate, and wherein, on sides thereof, concave rims form the first reel and the second reel.
